(19) United States
(12) Patent Application Publication
(10) Pub. No.: US 2018/0265773 A1
(43) Pub. Date: Sep. 20, 2018

(54) AQUEOUS PARTICULATE SLURRIES AND METHODS OF MAKING THE SAME

(71) Applicant: TRICAN WELL SERVICE LTD, Calgary (CA)

(72) Inventor: Kewei ZHANG, Calgary (CA)

(21) Appl. No.: 15/921,179

(22) Filed: Mar. 14, 2018

Related U.S. Application Data
(60) Provisional application No. 62/471,197, filed on Mar. 14, 2017.

(51) Int. Cl. C09K 8/80; C09K 8/68; C09K 8/70

(52) U.S. Cl. CPC C09K 8/805; C09K 8/703; C09K 8/68

(57) ABSTRACT

An aqueous slurry composition for use in industries such as petroleum and pipeline industries, such as for use as a fracturing fluid. The aqueous slurry composition includes a particulate, an aqueous liquid and a chemical compound that renders the particulate surface hydrophobic. The slurry is produced by rendering the surface of the particulate hydrophobic during or prior to making the slurry.

### REFERENCE TO RELATED APPLICATIONS

This application claims priority based on U.S. Provisional Application Ser. No. 62/471,197 filed Mar. 14, 2017, incorporated herein by reference in its entirety.

### FIELD OF THE INVENTION

This invention relates generally to aqueous slurry compositions utilized in the oil and gas industry and methods for making the same.

### BACKGROUND OF THE INVENTION

Without limiting the scope of the invention, its background is described in connection with existing aqueous slurries commonly used in the oil and gas industry to transport particulates through a pipe or tube either above ground, or from the surface to a subterranean formation or from a subterranean formation to the surface. Such aqueous slurries basically include an aqueous medium and particulates. The commonly used particulates include sand, ceramic particulates, glass spheres, bauxite (aluminum oxide) particulates, resin coated particulates and synthetic particulates. In general, sand is the most commonly used particulate. The particulates normally range in size from about 10 to about 200 U.S. mesh, which is from about 75 to 2000 μm in diameter, and have densities significantly higher than water. For example, the density of sand is typically about 2.6 g/cm³ while the density of water is 1 g/cm³.

Aqueous slurries are widely used in oil and gas industry in operations including drilling and hydraulic fracturing. To make a relatively stable slurry, the particulates must be suspended in a liquid medium, in most cases an aqueous medium, for a lengthy period of time at static and/or dynamic conditions, and therefore the viscosity or viscoelasticity of the liquid medium must be sufficiently high to be able to suspend the particulates. The most commonly used method for increasing viscosity or viscoelasticity of an aqueous liquid is by adding sufficient amount of a viscosifier, such as for example, a natural or synthetic polymer or a viscoelastic surfactant, to the liquid medium to form a gel.

Hydraulic fracturing is a technology used to enhance oil and gas production from a subterranean formation. During the operation, a fracturing fluid is injected through a wellbore into a subterranean formation at a pressure sufficient to initiate fractures in the formation. Frequently, the fracturing fluid comprises particulates, commonly known as proppants, suspended in the fluid and transported as a slurry into the fractures. At the last stage of the fracturing operation, fracturing fluid is flowed back to the surface leaving the proppants in the fractures. The proppants form proppant packs which prevent the newly-formed fractures in the subterranean formation from closing after pressure is released (i.e., the particulates “prop” open the factures). The proppant packs provide highly conductive channels for liquid or gaseous hydrocarbons to effectively seep through the subterranean formation to the wellbore.

Fracturing fluids can include various aqueous-based and/or non-aqueous based (e.g., hydrocarbon-based) fluids. Due to their low cost and high versatility, aqueous-based fluids are preferred and most commonly used. To effectively transport particulates, a sufficient amount of water-soluble viscosifiers, such as polymers (i.e., linear or cross-linked polymers) or viscoelastic surfactants are required to form a gel. For example, a sufficient amount of a water soluble polymer, such as guar gum or its derivatives, is added into an aqueous liquid wherein the physical entanglement of polymer chains form a gel increasing the fluid viscosity/viscoelasticity and thus increasing its ability to suspend particulates therein. To further enhance fluid viscosity, it is common to chemically cross-link polymer chains using certain chemical compounds to form a cross-linked gel. For example, borates can be used to cross-link guar gum. Compared to the cross-linked fluid, linear gels, i.e., fluids containing sufficient amount of polymers without crosslinking, cause less formation damage and are more cost-effective, but have relatively poor suspension capability. Viscoelastic surfactants also cause less formation damage, but are much more expensive. In recent years, slick water, i.e., water containing very small amounts of friction reducing agent (usually in the range from about 0.015% to 0.06% of the fluid), is widely used as a fracturing fluid, especially for fracturing shale formations. Polyacrylamides, including different polyacrylamide copolymers, are popular friction reducing agents in hydraulic fracturing operations.

As noted above, the last stage of a fracturing treatment involves the flowing of the fracturing fluid back from the fractures in the subterranean formation to the surface via the wellbore while the proppants are left in the fractures. It is not unusual for a significant amount of proppant to be carried out of the fractures and into the wellbore along with the fluids being flowed back out the well. This process is known as proppant flowback. Proppant flowback is highly undesirable because it not only reduces the amount of proppants remaining in the fractures, resulting in less conductive channels, but also causes significant operational difficulties. This problem has long plagued the oil and gas industry because of its adverse effect on well productivity and equipment. Numerous methods have been attempted in an effort to find a solution to the problem of proppant flowback. One solution to proppant flowback has been the use of so-called “resin-coated proppants.” The outer surfaces of the resin-coated proppants have an adherent resin coating so that the proppant grains are bonded to each other under suitable conditions forming a permeable barrier and reducing the proppant flowback (i.e., the proppant grains become tacky and stick together to reduce proppant flowback). U.S. Pat. Nos. 4,585,064 and 6,047,772 provide examples of such resin-coated proppants, the contents of which are incorporated by reference herein in their entirety.

There are significant limitations to the use of resin-coated proppants, including that the method is expensive and operationally challenging. For example, resin-coated proppants are much more expensive than normal sands, especially considering that a fracturing treatment usually employs hundreds or thousands tons of proppants in a single well. Normally, when the formation temperature is below 60° C., activators are required to make the resin-coated proppants bind together. This further increases the cost.

There is thus a need for a composition and method for making proppant-containing slurries which can form stable proppant packs and resist/reduce proppant flowback, while at the same time are more cost effective and/or operationally simple.

In oil sand operations, massive amounts of sands are left after oil is stripped off the oil sand surface. Finding a more cost effective way to transport sands efficiently over distance through pipelines has long been required in the industry. Thus, a composition and a method for making stable and highly fluid sand slurries to transport sands through pipes at low cost would be quite useful. U.S. Pat. Nos. 7,723,274 and 8,105,986, the contents of which are incorporated herein in their entirety, describe different ways of enhancing the transporting capability of a slurry. Instead of focusing on improving fluid rheology, the patents are directed to enhancing the transporting capability of a slurry by rendering the particulate surfaces sufficiently hydrophobic to attach micro gas bubbles to the particulate surfaces, and thus, buoying the particulates up. Consequently, particulates can be transported into the formation effectively without requiring gelling of the fluid. Different hydrophobising agents, including silicone compounds or hydrocarbon amines, are also described in U.S. Pat. Nos. 7,723,274 and 8,105,986.

The recent rise in multi-stage fracturing in shale formations has resulted in massive increases in sand usage, and consequently sand shortages. Lower quality sand, so-called Tier 2 sand, which has a lower mechanical strength and generates more fines under formation stress, has recently been used more often. Therefore, there is need for compositions and methods that can improve sand quality by reducing fines generation under formation pressure.

### SUMMARY OF THE INVENTION

Aqueous slurry compositions are provided herein, including methods of making and using such compositions, which are intended to address some of the deficiencies and problems with known slurry compositions. Aqueous slurry compositions according to various aspects of the present disclosure comprise an aqueous liquid, particulates and a silicone-modified hydrophobic polymer. This composition can be used in different operations including reducing proppant flow-back and transporting particulates including oil sands through pipes or tubes.

According to one aspect of the present invention there is provided an aqueous slurry composition comprising an aqueous liquid, particulates and a silicone-modified hydrophobic polymer that renders the surface of the particulates hydrophobic, and the method of making such an aqueous slurry composition.

According to another aspect of the present invention, there is provided an aqueous fracturing slurry composition comprising an aqueous liquid, particulates and silicone-modified hydrophobic polymer that renders the surface of the proppants hydrophobic, and a frother. Methods of making such aqueous fracturing slurry compositions including frothers are provided.

According to a further aspect of the present invention, there is provided an aqueous fracturing slurry composition comprising an aqueous liquid, particulates, silicone-modified hydrophobic polymer that renders the surface of the particulates hydrophobic, and a gas. Methods of making such aqueous fracturing slurry compositions including a gas are provided.

According to another aspect of the present invention, there is provided an aqueous fracturing slurry composition comprising an aqueous liquid, particulates and silicone-modified hydrophobic polymer that renders the surface of the particulates hydrophobic, and an oil. Methods of making such aqueous fracturing slurry compositions including an oil are provided.

According to another aspect of the present invention, there is provided an aqueous fracturing slurry composition comprising an aqueous liquid, particulates and silicone-modified hydrophobic polymer that renders the surface of the particulates hydrophobic, and two or more of a frother, a gas, and an oil. Methods of making such aqueous fracturing slurry compositions including two or more of a frother, a gas, and an oil are provided.

According to one aspect of the present invention there is provided an aqueous slurry composition comprising an aqueous liquid and particulates at least partially coated with a silicone-modified hydrophobic polymer that renders the surface of the particulates hydrophobic, and the method of making such an aqueous slurry composition.

According to another aspect of the present invention, there is provided an aqueous fracturing slurry composition comprising an aqueous liquid, particulates at least partially coated with a silicone-modified hydrophobic polymer that renders the surface of the particulates hydrophobic, and a frother. Methods of making such aqueous fracturing slurry compositions including frothers are provided.

According to a further aspect of the present invention, there is provided an aqueous fracturing slurry composition comprising an aqueous liquid, particulates at least partially coated with a silicone-modified hydrophobic polymer that renders the surface of the particulates hydrophobic, and a gas. Methods of making such aqueous fracturing slurry compositions including a gas are provided.

According to another aspect of the present invention, there is provided an aqueous fracturing slurry composition comprising an aqueous liquid, particulates at least partially coated with a silicone-modified hydrophobic polymer that renders the surface of the particulates hydrophobic, and an oil. Methods of making such aqueous fracturing slurry compositions including an oil are provided.

According to another aspect of the present invention, there is provided an aqueous fracturing slurry composition comprising an aqueous liquid, particulates at least partially coated with a silicone-modified hydrophobic polymer that renders the surface of the particulates hydrophobic, and two or more of a frother, a gas, and an oil. Methods of making such aqueous fracturing slurry compositions including two or more of a frother, a gas, and an oil are provided.

According to another aspect of the present invention, there is provided a method for preventing fugitive particulates, i.e., particulates suspended in air by wind action and/or human activities, by coating particulates with a silicone-modified hydrophobic polymer.

According to another aspect of the present invention, there is provided a method for preventing fugitive particulates by coating particulates with a silicone-modified hydrophobic polymer and subsequently mixing the hydrophobically-coated particulates with an oil.

According to another aspect of the present invention, there is provided a composition and method of improving sand quality.

### BRIEF DESCRIPTION OF THE DRAWINGS

For a more complete understanding of the present invention, including features and advantages, reference is now made to the detailed description of the invention along with the accompanying figures:

FIG. 1 is a schematic illustration of a particulate coated with a silicone-modified hydrophobic polymer in accordance with various aspects of the present disclosure;

FIG. 2 is a schematic illustration of multiple particulates coated with the same silicone-modified hydrophobic polymer in accordance with various aspects of the present disclosure; and

FIG. 3 is a schematic illustration of two particulates, each coated with a silicone-modified hydrophobic polymer, physically bound to each other via an oil “bridge.”

### DETAILED DESCRIPTION OF THE INVENTION

While the making and using of various embodiments of the present invention are discussed in detail below, it should be appreciated that the present invention provides many applicable inventive concepts which can be employed in a wide variety of specific contexts. The specific embodiment discussed herein are merely illustrative of specific ways to make and use the invention and do not delimit the scope of the invention.

To facilitate the understanding of this invention, and for the avoidance of doubt in construing the claims herein, a number of terms are defined below. Terms defined herein have meanings as commonly understood by a person of ordinary skill in the areas relevant to the present invention. The terminology used to describe specific embodiments of the invention does not delimit the invention, except as outlined in the claims.

Terms such as “a,” “an,” and “the” are not intended to refer to a singular entity unless explicitly so defined, but include the general class of which a specific example may be used for illustration. The use of the terms “a” or “an” when used in conjunction with “comprising” in the claims and/or the specification may mean “one” but may also be consistent with “one or more,” “at least one,” and/or “one or more than one.”

The use of the term “or” in the claims is used to mean “and/or” unless explicitly indicated to refer to alternatives as mutually exclusive. Thus, unless otherwise stated, the term “or” in a group of alternatives means any one or combination of the members of the group. Further, unless explicitly indicated to refer to alternatives as mutually exclusive, the phrase “A, B, and/or C” means embodiments having element A alone, element B alone, element C alone, or any combination of A, B, and C taken together.

Similarly, for the avoidance of doubt and unless otherwise explicitly indicated to refer to alternatives as mutually exclusive, the phrase “at least one of” when combined with a list of items, means a single item from the list or any combination of items in the list. For example, and unless otherwise defined, the phrase “at least one of A, B and C,” means “at least one from the group A, B, C, or any combination of A, B and C.” Thus, unless otherwise defined, the phrase requires one or more, and not necessarily not all, of the listed items.

The terms “comprising” (and any form thereof such as “comprise” and “comprises”), “having” (and any form thereof such as “have” and “has”), “including” (and any form thereof such as “includes” and “include”) or “containing” (and any form thereof such as “contains” and “contain”) are inclusive or open-ended and do not exclude additional, unrecited elements or method steps.

The term “effective” as used in the specification and claims, means adequate to provide or accomplish a desired, expected, or intended result.

The terms “about” or “approximately” are defined as being close to as understood by one of ordinary skill in the art, and in one non-limiting embodiment the terms are defined to be within 10%, within 5%, within 1%, and in certain aspects within 0.5%.

For purposes of this specification and the claims appended thereto, the term “hydrophobic polymer” is used herein to mean any polymer that is non-wetting to water and typically has a water contact angle approximately equal to or greater than 90°. Examples of hydrophobic polymers, by way of illustration only, include: (a) polyolefins, which is a class of polymers, copolymers, or terpolymers synthesized from one or more simple olefins as monomers including, but not limited to, ethylene, propylene and butene. Polyolefins include, but are limited to, polyethylene, polypropylene, polybutene, polyisobutylene, poly(isoprene), poly(4-methyl-1-pentene), ethylene-propylene copolymers, ethylene-propylenehexadiene copolymers, ethene-propene-butene copolymers and ethylene-vinyl acetate copolymers; (b) styrene polymers, including poly(styrene), poly(2-methyl styrene), styrene-acrylonitrile copolymers having less than about 20 mole-percent acrylonitrile; (c) vinyl polymers, such as poly(vinyl butyrate), poly(vinyl decanoate), poly(vinyl dodecanoate), poly(vinyl hexadecanoate), poly(vinyl hexanoate), poly(vinyl propionate), poly(vinyl octanoate), and poly(methacrylonitnile); (d) acrylic polymers, including poly(n-butyl acetate), poly(ethyl acrylate); methacrylic polymers, such as poly(benzyl methacrylate), poly(n-butyl methacrylate), poly(isobutyl methacrylate), poly(t-butyl methacrylate), poly(dodecyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate); (e) polyesters, such as poly(ethylene terephthalate), poly(butylene terephthalate), and poly(ethylene terenaphthalate), and (f) polyurethanes, which are polymers or copolymers where the units are joined by carbamate (urethane) links. Normally hydrophobic polymers of low or moderate average molecular weights are preferred such as from about a few hundred to about 500,000. Furthermore, hydrophobic polymers that are liquid or viscous liquid at moderate conditions, such as about 0.5 to about 10 atmospheres of pressure and temperatures ranging from about 25 to about 200° C., are also preferred.

The term “silicone-modified hydrophobic polymer” is used herein to mean any hydrophobic polymer that is modified by attaching one or more reactive silane, siloxane, or polysiloxane groups, or their derivatives, to one or more end units of the polymer, one or more inner units of the polymer, a middle unit of the polymer, or any combination thereof. Different silicone groups can be grafted to the hydrophobic polymers including, siloxanes modified with cationic species such as alkylammonium groups, or organosilanes having hydrolysable groups, such as alkoxysilanes or halosilanes. General structures of organosilanes that can be used as include, but are not limited to, structures according to formula I:

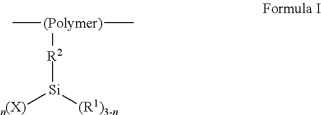

wherein
n is an integer ranging from 1 to 3;
X is an alkoxy group such as —OCH₃, —OCH₂CH₃, —OCH₂CH₂CH₃, —OC(CH₃)₃, —OCH₂CH₂OCH₃, or a halogen such as Cl, Br, I or F (preferably Cl or Br);
R¹ is a functional group such as —H, —CH₃, —(CH₂)ₘCH₃ (m=1-23), —C₆H₅, —C₆H₄R (R=a hydrophobic group such as, but not limited to, a C₁-C₂₄ saturated or unsaturated, branched or linear alkyl group, a halogen, a vinyl, an alkoxy, an aromatic hydrocarbon, a cyclic hydrocarbon, etc.), —HC═CH₂, —(CH₂)ₘHC═CH₂ (m=1-23), —C≡CH, —(CH₂)ₘC≡CH (m=1-23), a cyclic hydrocarbon or a branched alkane such as a isopropyl, iso-, tert-, or sec-butyl, iso-, tert-, or sec-pentyl, iso-, tert- or sec-hexyl, iso-, tert-, or sec-heptyl, iso-, tert- or sec-octyl; and
R² is a linear or branched, substituted or unsubstituted, alkyl, alkenyl or alkynyl chain having 1 to 24 carbons.

The presence of, especially, hydrolysable silane groups allows the polymers to chemically bind to the surface of the particulates such as sand. Examples of silane-modified hydrophobic polymers, by way of illustration only, include: (a) silane-modified polyolefin including silane-modified polybutyl, silane-modified polyisobutylene silane-modified polyethylenes, silane-modified olefin copolymer and silane-modified polypropylenes and the copolymers; (b) silane-modified styrene polymers; (c) silane-modified vinyl polymers; (d) silane-modified acrylate polymers including silane-modified poly(t-butyl methacrylate), poly(t-butylaminoethyl methacrylate); (e) silane-modified polyesters; and (f) silane-modified polyurethanes, including alkoxysilane-terminated polyurethane. The especially preferred are silane-modified polyolefins including homo- and copolymers such as polyethylene and polypropylene, and copolymers of ethylenepropylene, ethylene-butene, ethylene-hexene, ethylene-vinyl-acetate, vinyl-acetate, ethylenemethyl-acrylate, ethylene-ethyl-acrylate, ethylene-butyl-acrylate and ethylene-propylene, and (f) silane-modified polyurethanes including alkoxysilane-terminated polyurethane. These silane-modified polymers are commercially available from, for example, Evonik Industries and ShinEtsu Silicone.

Examples of silane-modified polymers and copolymers, and preparations thereof as aqueous dispersions can be found in various patents including U.S. Pat. Nos. 3,729,438; 3,814,716; 6,455,637; 6,863,985 and 8,476,375, which are incorporated by reference herein in their entirety.

The term “frother” is used herein to mean compounds that act to stabilize bubbles in the slurry. In accordance with various aspects of the present disclosure, frothers that can be used, alone and in mixtures, include: a) aliphatic alcohols, including particularly, methyl isobutyl carbinol (“MIBC”, having the chemical formula CH₃CHCH₃CH(OH)CH₃), 2,2,4-trimethylpentanediol 1,3-monoisobutyrate (TEXANOL®), 2-ethyl hexanol, n-pentanol, n-butyl, n-hexanol, 2-butanol, n-heptanol, n-octanol, isoamyl alcohol, and mixtures of C₆-C₉ alcohols, mixtures of C₄-C₇ alcohols and mixtures of C₅-C₈ alcohols; b) cyclic alcohols, ethers, terpenes and ketones largely from natural oil sources including but not limited to pine oil, terpineol, borneol, and fenchyl alcohol; c) alkoxy paraffins such as 1,1,3,-triethoxybutane (TEB); and d) polyglycol ethers, polypropylene glycol ethers and polyglycol glycerol ethers, represented by commercial products such as the Dowfroths (DF#) and XK# series polyglycol glycerol ethers by Dow Chemical Company, Ucon and PPG frothers from Union Carbide, Aerofroths (AF#) from Cyanamid, and Techfroths from ICI. In some instances, a mixture of the frothers, such as a mixture of two or more alcohols, can be used. In some instances, oils including hydrocarbon oils such as mineral oils or paraffin oils and natural oils can be used alone or in combination with, for example, an alcohol frother, to stabilize gas bubbles on the particulate surfaces and enhance particulate agglomeration.

The terms “aqueous liquid”, “aqueous fluid” and “aqueous medium” mean water, slick-water, salt-containing solutions, water or slick-water containing additive(s), salt(s) alcohol(s) or other organic solvent(s), or any combination thereof. It should be understood that the additives other than water in the aqueous liquid are used in amounts or in a manner that does not adversely affect the present invention.

The size of particulates (i.e., proppants) in compositions according to the invention is generally between about 10-200 U.S. mesh, which is about 75 to 2000 μm in diameter. It should be understood that the size distribution of the proppants can be narrow or wide. Suitable proppants include sands, ceramic proppants, glass beads/spheres, bauxite proppants, resin coated sands, synthetic particulates and any other proppants known in the industry.

Aqueous slurry compositions according to various aspects of the present disclosure can be made on the surface at or near a wellsite or in situ in a subterranean formation.

In some instances, such aqueous slurry compositions include an aqueous liquid, particulates and a silicone-modified hydrophobic polymer for rendering the surface of the particulates hydrophobic. In some instances, such aqueous slurry compositions include an aqueous liquid, particulates, a silicone-modified hydrophobic polymer and a frother. In some instances, such aqueous slurry compositions include an aqueous liquid, particulates, a silicone-modified hydrophobic polymer and a gas. In some instances, such aqueous slurry compositions include an aqueous liquid, particulates, a silicone-modified hydrophobic polymer and an oil. In some instances, such aqueous slurry compositions include an aqueous liquid, particulates, a silicone-modified hydrophobic polymer and two or more of a frother, a gas, and an oil.

In some instances, such aqueous slurry compositions include an aqueous liquid and particulates which are at least partially coated with a silicone-modified hydrophobic polymer, rendering the surface of the particulates hydrophobic. In some instances, such aqueous slurry compositions include an aqueous liquid, particulates which are at least partially coated with a silicone-modified hydrophobic polymer, and a frother. In some instances, such aqueous slurry compositions include an aqueous liquid, particulates which are at least partially coated with a silicone-modified hydrophobic polymer, and a gas. In some instances, such aqueous slurry compositions include an aqueous liquid, particulates which are at least partially coated with a silicone-modified hydrophobic polymer, and an oil. In some instances, such aqueous slurry compositions include an aqueous liquid, particulates which are at least partially coated with a silicone-modified hydrophobic polymer, and two or more of a frother, a gas and an oil.

When a frother is incorporated into an aqueous slurry in accordance with various aspects of the present disclosure, the concentration of the frother in the aqueous slurry, in L of frother per m³ of aqueous slurry, can range from about 0.01 L/m³ to about 4 L/m³, alternatively from about 0.1 L/m³ to about 3 L/m³, alternatively from about 0.2 L/m³ to about 2 L/m³, alternatively from about 0.3 L/m³ to about 1 L/m³, alternatively from about 0.4 L/m³ to about 0.8 L/m³, and alternatively from about 0.5 L/m³ to about 0.6 L/m³.

Suitable gases include air, carbon dioxide, nitrogen, methane and mixtures thereof. The gas can be introduced into the slurry during preparation thereof. For example, when the slurry is pumped through a pipe, gas such as air or nitrogen can be mixed into the slurry. When a gas is incorporated into an aqueous slurry in accordance with various aspects of the present disclosure, the amount of the gas in the aqueous slurry, in volume/volume percent (v/v %), can range from about 0.1 v/v % to about 20 v/v %, alternatively about from about 0.1 v/v % to about 10 v/v %, and alternatively about from about 0.1 v/v % to about 5 v/v %. It worth noting this is different from a foam fracturing fluid where not only the fluid is gelled but further foamed with a foaming agent with at least 50% or 60% of a gas.

When an oil is incorporated into an aqueous slurry in accordance with various aspects of the present disclosure, the concentration of the oil in the aqueous slurry, in L of oil per m³ of aqueous slurry, can range from about 0.5 L/m³ to about 12 L/m³, alternatively about from about 1 L/m³ to about 10 L/m³, alternatively from about 3 L/m³ to about 9 L/m³, alternatively from about 4 L/m³ to about 8 L/m³, alternatively from about 5 L/m³ to about 7 L/m³, and alternatively from about 6 L/m³ to about 7 L/m³.

For rendering the surface of particulates hydrophobic, silicone-modified polyolefins such as alkoxy- or halo-silane modified polyolefins, such as the silane-modified polyethylene, silane-modified polypropylene or their respective copolymers, or silane-modified vinyl-acetate can be used. In some instances, such silicone-modified polyolefins can be used as aqueous dispersions. Without being bound to theory, it is believed that organosilanes and halosilanes undergo a hydrolysis and condensation reaction with silanols located on silica surfaces of particulate materials, to form a covalent bond between the silicon portion of the silane and the silica surfaces, coupling the silane and silica surface via an Si—O—Si linkage. In the case of organosilanes, an alcohol is formed as a reaction byproduct from the hydrogen of the silanol and the alkoxy groups of the organosilane. In the case of halosilanes, an acid is formed as a reaction byproduct from the hydrogen of the silanol and the halogens of the halosilane.

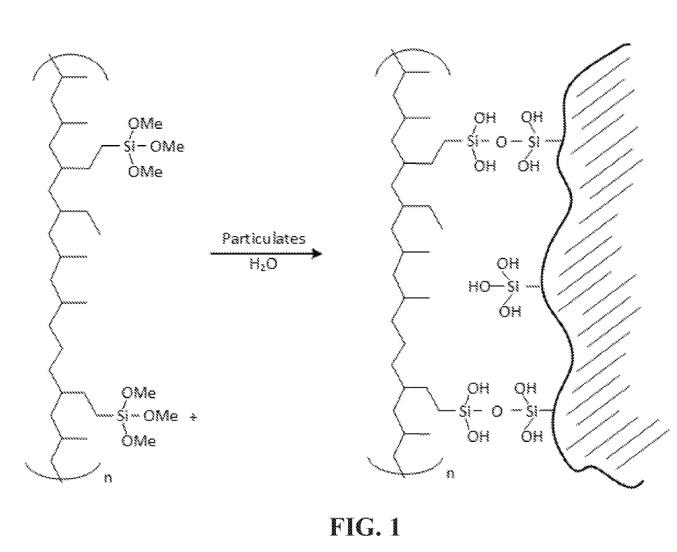

One example of such an alkoxysilane-modified poly-α-olefin is commercially available under the tradename VESTOPLAST® 206 from Evonik. VESTOPLAST® 206 is manufactured for use as an adhesive for adhering plastics to wood, glass, ceramics and metals. VESTOPLAST® 206 has the chemical structure depicted in FIG. 1. Properties of this alkoxysilane-modified poly-α-olefin include: a molecular mass of 10,600 M_{N} and a molecular weight of 38,000 Mw, a melt viscosity of 5,000±1,000 mPa s (based on DIN 53 019), and a softening point of 98±4° C. (by the ring and ball method). The melt viscosity of this alkoxysilane-modified poly-α-olefin decreased rapidly from a melt viscosity of ˜22,500 mPa s at 120° C. to ˜4,500 mPa s at 190° C. Suitable alkoxysilane-modified poly-α-olefins such as for example VESTOPLAST® 206 appear at room temperature as waxy thermoplastics that are supplied in as powdered granules wherein the powdering prevents aggregation of the granules. Suitable alkoxysilane-modified poly-α-olefins such as for example VESTOPLAST® 206, will melt under the elevated temperatures of the downhole environment. The melting alkoxysilane-modified poly-α-olefins are activated and begin crosslinking (curing) by exposure to water. The alkoxysilane-modified poly-α-olefins will crosslink to each other and also to silanol (Si—OH) groups present on the surface of sands (i.e., particulates/proppants). In certain embodiments, the silicone modified hydrophobic polymers bind either physically (for example, by van der Waals forces, electrostatic interactions, or hydrogen bonding) or chemically (for example, by the formation of a covalent bond) to the particulates/proppants.

In some instances, diethoxymethylsilyl-modified poly-1,2-butadiene (50% in toluene, Gelest, product code SSP-058) is used as the silicone-modified hydrophobic polymer for hydrophobizing the surface of particulates. In some instances, triethoxymethylsilyl-modified poly-1,2-butadiene (Gelest, CAS No. 72905-90-9) is used as the silicone-modified hydrophobic polymer. In some instances, (30-35% triethoxysilylethyl)ethylene-(35-40% 1,4-butadiene)-(25-30% styrene) terpolymer (50% in toluene, Gelest, Product Code SSP-255) is used as the silicone-modified hydrophobic polymer. In some instances, trimethoxysilyl modified polyethylene (Gelest, Product Code SSP-050, CAS No. 35312-82-4) is used as the silicone-modified hydrophobic polymer.

In some instances, an oligomeric hydrosylate of vinyltrimethoxysilane (Gelest, Product Code SIV9220.2, CAS No. 131298-48-1) or vinyltriethoxysilane (Gelest, Product Code SIV9112.2, CAS No. 29434-25-1) is used as the silicone-modified hydrophobic polymer for hydrophobizing the surface of particulates. In some instances, an oligomeric co-hydrosylate of vinyltriethoxysilane-propyltriethoxysilane (Gelest, Product Code SIV9112.3, CAS No. 201615-10-3) is used as the silicone-modified hydrophobic polymer. In some instances, an oligomeric hydrosylate of methyltrimethoxysilane (Gelest, Product Code SIM6555.2, CAS No. 67762-97-4) is used as the silicone-modified hydrophobic polymer. In some instances, an oligomeric hydrosylate of isooctyltrimethoxysilane (Gelest, Product Code SII6458.2, CAS No. 107712-67-4) is used as the silicone-modified hydrophobic polymer. In some instances, an oligomeric co-hydrosylate of phenyltrimethoxysilane-methyltrimethoxysilane (Gelest, Product Code SIP6822.3) is used as the silicone-modified hydrophobic polymer.

There are different methods to make the slurries. As discussed above, aqueous slurry compositions according to various aspects of the present disclosure can be made on the surface at or near a wellsite or in situ in a subterranean formation.

In some instances, aqueous slurries can be made with particulates which have previously been at least partially coated with a silicone-modified hydrophobic polymer. That is, in some instances, aqueous slurries can be made with pre-hydrophobized particulates. In other instances, aqueous slurries can be made with particulates and a silicone-modified hydrophobic polymer such that the particulates are at least partially coated with a silicone-modified hydrophobic polymer during formation of the aqueous slurry composition.

In yet other instances, the aqueous slurry can include particulates but not include a silicone-modified hydrophobic polymer. In such instances, the aqueous slurry can be transmitted from the ground surface to fractures within a subterranean formation and the particulates can be allowed to fill the fractures for proppant pack formation. After the particulates have been delivered to the fractures of the subterranean formation, a solution containing the silicone-modified hydrophobic polymer can be injected into the fractures to coat the particulates contained therein.

The proppants can be pre-treated to make their surfaces hydrophobic at, for example, a manufacturing site by spraying a liquid medium containing a silane-modified hydrophobic polymer, including aqueous emulsion in which the silane-modified hydrophobic polymer is dispersed as small particles, directly on the sand and then separating the proppants from the medium by drying. For example, an aqueous emulsion of small particles of silane-modified polyethylene or silane-modified propylene or one of their respective copolymer can be sprayed directly on the sand right after a sand heat-drying process. The pre-treated hydrophobically-coated sands can be shipped to a wellsite to make a slurry thereof on-the-fly, with water, for example, in a slick-water fracturing operation while the fluid is being pumped into the formation. Alternatively, the proppants such as sands can be pretreated on-the-fly onsite in a fracturing operation prior to being mixed with a fluid while pumping. The method of pre-treatment is disclosed in U.S. application Ser. No. 14/993,030 and is incorporated herein by reference.

Formation of pre-hydrophobized particulates, for later mixing with at least an aqueous liquid to form an aqueous slurry composition, can be accomplished using the following exemplary procedure. First, a silicone-modified hydrophobic polymer solution or emulsion is formed by mixing a silicone-modified hydrophobic polymer with a solvent. The solvent can be any solvent which does not adversely react with the silicone-modified hydrophobic polymer and/or does not adversely affect the ability of the silicone-modified hydrophobic polymer to physically (for example, by van der Waals forces, electrostatic interactions, or hydrogen bonding) or chemically (for example, by the formation of a covalent bond) bind to the particulates/proppants. In some instances, the solvent is an aliphatic solvent such as hexanes, a cycloalkane, cyclohexene, octane, nonane, undecane, and squalene. In some instances, the solvent is an aromatic solvent such as benzene, xylene or toluene. In some instances, the solvent can be an alcohol such as methanol, ethanol, isopropanol or butanol. The silicone-modified hydrophobic polymer can be mixed with the solvent such that the concentration of silicone-modified hydrophobic polymer in the solvent is less than about 10 wt %, alternatively less than about 8 wt %, alternatively less than about 6 wt %, alternatively about 4 wt % or less, and alternatively about 2 wt % or less. In accordance with various aspects of the present disclosure, the silicone-modified hydrophobic polymer is mixed with a solvent such that the concentration of silicone-modified hydrophobic polymer in the solvent between about 2 wt % and about 4 wt %.

Next, particulate materials are treated with the silicone-modified hydrophobic polymer solution or emulsion. Treatment can take place under ambient pressure at any temperature ranging from about room temperature (i.e., 20-25° C.) to a temperature below the boiling point of the solvent used. The particulate materials can be treated with the solution at a concentration ranging from about 0.1 liters (L) to about 5 L of mixture per ton of particulate material (about 0.1 L/ton to about 5 L/ton), alternatively about 0.2 L/ton to about 4 L/ton, alternatively about 0.3 L/ton to about 3 L/ton, alternatively about 0.4 L/ton to about 2 L/ton, alternatively about 0.5 L/ton, to about 1.5 L/ton, alternatively 0.6 L/ton to about 1 L/ton, alternatively about 0.7 L/ton to about 0.9 L/ton, and alternatively about 0.8 L/ton. The particulate materials can be treated while in a pile, in a container, on a conveyor system, in an agitating or shaking reaction vessel, etc. When the particulate materials are in a pile or on a conveyor system, the solution can be spray or otherwise coated onto the particulate materials.

When the particulate materials are in a container or reaction vessel, an amount of the solution can be placed in the container or reaction vessel for a predetermined period of time sufficient for silicone-modified hydrophobic polymer to physically or chemically bind to the particulate materials. If needed, the remaining or unreacted solution can then be removed from the container or vessel by a separation process such as for example, decantation, filtration, or evaporation leaving silicone-modified hydrophobic polymer-coated particulate materials in the container or vessel.

Pre-hydrophobized particulates can subsequently be transported to a well site and blended, in a blender, at the ground surface with an aqueous liquid and, optionally, one or more of a frother, a gas and an oil to make an aqueous slurry composition which is then pumped from the ground surface to fractures of a subterranean formation. Alternatively, the pre-hydrophobized particulates can be added to an aqueous liquid and, optionally, one or more of a frother, a gas and an oil while pumping downhole. In either case, a frother or a frother/oil combination can be added either before or after the pre-hydrophobized particulates are added to the blender, to enhance the flotation and agglomeration of the particulates. Furthermore, the gas, such as air, nitrogen, carbon dioxide and/or mixtures thereof, can be mixed into the slurry under sufficient agitation. For example, during a fracturing operation, the pre-hydrophobized proppants can be mixed into an aqueous fluid on the suction side of the blender while a gas, for example, nitrogen, can be added into the slurry on the discharge side or a point close to wellhead.

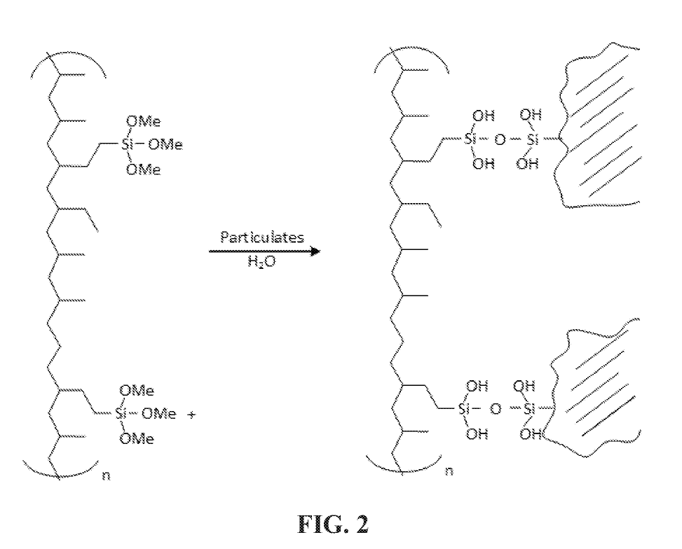

In another embodiment of a fracturing operation, silane-modified poly-α-olefin granules (such as VESTOPLAST® 206) are added to an aqueous slurry composition containing proppants (i.e., particulates) prior to or as the slurry is pumped downhole. In field operations, proppants are pumped into fractures of a subterranean formation including granules of an alkoxysilane-modified polyolefin. The granules of alkoxysilane-modified poly-α-olefin, alone or together with further proppants, may be pumped into the formation following an initial proppant stage to mix with particulates already in the formation. As the proppant slurry including the alkoxysilane-modified poly-α-olefin reaches the formation and encounters the heat of the formation, the alkoxysilane-modified poly-α-olefin begins to melt. Crosslinking of the alkoxysilane-modified poly-α-olefin to a single particulate and to more than one sand particulate, as depicted in FIGS. 1 and 2, respectively, is induced by exposure to water. As shown, the alkoxysilane-modified poly-α-olefin is bound to the particulate surface via an Si—O—Si linkage. The rate of crosslinking is encouraged by the elevated heat of the formation. If desired the crosslinking rate may be accelerated by addition of a promoter. One example of a promoter for crosslinking of silane-modified poly-α-olefin is dibutyl tin dilaurate (DBTL).

The present invention can be used in different aqueous fracturing fluids. It is especially beneficial to use the present invention in slick-water fracturing operations, wherein the fluid itself has very limited proppant transportation capability. In slick-water, a very low concentration of a friction-reducing agent such as polyacylamide polymers or copolymers including hydrophobically modified polyacylamides is used. For example, during a slick-water fracturing operation, the pre-hydrophobized particulates can be mixed into slick-water on the suction side of the blender while a gas, for example, nitrogen or carbon dioxide, is added and mixed into the slurry flowing through a pipe at high rate on the discharge side or a point close to the wellhead and then pumped downhole into a subterranean formation. Similarly, it is beneficial to use the present invention in a linear gel having a viscosity in general between about 15 and about 30 cp at 511 s⁻¹.

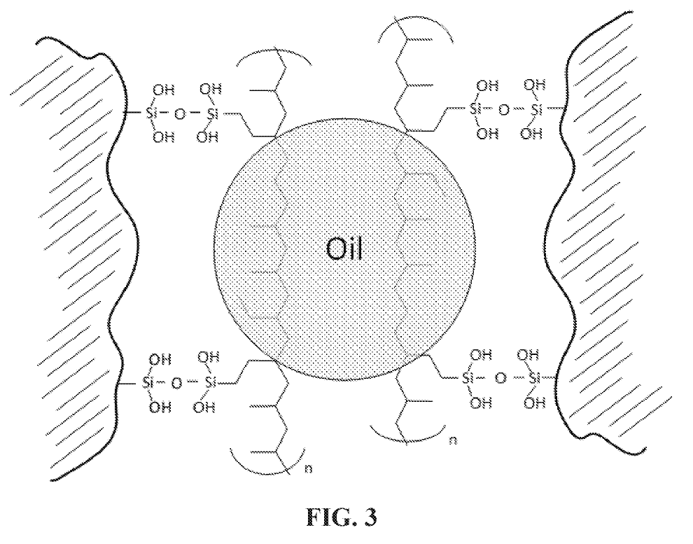

In certain embodiments, a method for preventing proppant flowback after a hydraulic fracturing operation is provided. To prevent proppant flowback, different oils, including hydrocarbon oils, mineral oils, vegetable oils, or mixtures thereof, can be included in an aqueous slurry composition to increase the agglomeration of proppants, which promotes the retention of proppant packs within fractures of a subterranean formation. Specifically, without being bound to any particular theory, it is believed that the oil physically binds via van der Waals forces to a hydrophobic portion of the silicone-modified hydrophobic polymer on the surface of the particulate. Furthermore, the oil acts as a “bridge” between adjacent or close proximity hydrophobically-coated proppants by a physical interaction between the oil and hydrophobic/nonpolar portion of the silicone-modified hydrophobic polymer bound to each of the adjacent or close proximity particulates (FIG. 3). By virtue of the combined effect of the oil and the silicone-modified hydrophobic polymer, individual particulates are aggregated and become trapped in the formation thus preventing flow-back.

Slurries according to various aspects of the present disclosure are particularly useful in gravel-pack operations where a proppant-containing slurry is normally pumped into a wellbore to prevent excessive amount of sands from flowing into the wellbore from the formation. The present method is cost effective and the proppant pack formed has a high conductivity. Similarly, slurries according to various aspects of the present disclosure can also be used in so-called formation consolidation operations. In such an operation, a fluid containing an, for example, silicone-modified hydrophobic polymer such as an aqueous dispersion of an alkoxysilane-terminated polyurethane, is injected into a formation to increase cohesiveness among individual particulates (i.e., proppants) to consolidate the formation and to reduce proppant production.

In accordance with various aspects of the present disclosure, compositions and methods for hydrophobizing particulates can utilize a silicone-modified hydrophobic polymer in combination with a non-polymeric organosilicon, a polysiloxane, or a fluoro-organic compound, such those disclosed in U.S. Pat. No. 7,723,274, incorporated herein by reference. Also, accordance with various aspects of the present disclosure, compositions and methods for hydrophobizing particulates can utilize an alkyl amine, as disclosed in U.S. Pat. No. 8,105,986, also incorporated herein by reference. Alternatively, in all aforementioned compositions and methods for hydrophobizing the particulates, different silane-modified hydrophobic polymers can be used together.

In accordance with various aspects of the present disclosure, a silicone-modified hydrophobic polymer can be coated onto a particulate to prevent the particulates from becoming airborne (that is becoming fugitive particulates) during transport, transfer from one vessel to another, or during formation of aqueous slurry compositions at a wellsite. Silicone-modified hydrophobic polymers in accordance with various aspect of the present disclosure may be sprayed, coated, or otherwise applied, onto particulates, such as sand, so that the particulates are less easily picked up and carried away by air currents or. The use of silicone-modified hydrophobic polymers described herein, therefore, prevent dusts, especially siliceous dusts, from forming in the surrounding environment where it can harm individuals or equipment and pose a safety hazard.

The following examples are included for the sake of completeness of disclosure and to illustrate the methods of making the compositions and composites of the present invention as well as to present certain characteristics of the compositions. In no way are these examples intended to limit the scope or teaching of this disclosure.

### Example 1A. Evonik V206, Sand Floating Test

Sixty grams of 40/70 US mesh frac sand was mixed with one milliliter of xylene containing 4 wt % Evonik VESTOPLAST® 206, an alkoxysilane-modified poly-alpha-olefin, to form a poly-alpha-olefin coated sand. After being dried, the coated sand was added into a lab blender which contained 200 ml of a 0.1 wt % polyacrylamide aqueous solution. The slurry was sheared at 3000 rpm for 15 seconds. It was observed that almost all of the sand was floating on the top of slurry.

### Example 1B. Evonik V206, Crush Resistance Test

Forty grams of 40/70 US mesh frac sand was mixed with 0.67 ml of xylene containing 4 wt % Evonik VESTOPLAST® 206, an alkoxysilane-modified poly-alpha-olefin, to form a poly-alpha-olefin coated sand. After the coated sand was dried, the coated sand was subjected to a crush resistance test conducted under 5000 psi by using standard (ISO 13503-2) procedures. Test results shows 7.3 wt % fines were generated for the untreated sand after being crushed. By comparison, only 5.0 wt % fines were generated for the coated sand under the same experimental conditions, constituting an approximately 32% fine reduction with the coated sand as compared to the uncoated sand.

### Example 1C. Evonik V206, Turbidity Test

Thirty grams of 40/70 US mesh frac sand was mixed with 0.5 ml of xylene containing 4 wt % Evonik VESTOPLAST® 206, an alkoxysilane-modified poly-alpha-olefin. After being dried, the sand was added into a glass bottle containing 100 mL of distilled water. The bottle was shaken for 30 seconds and then let it stand for 5 minutes. Afterwards 25 mL of the water was extracted and turbidity was measured on a HACH spectrometer at 450 nm wavelength. Result shows the turbidity of the coated sand was 2 FTU. By comparison, the turbidity of untreated sand, under the same experimental conditions, was 23 FTU.

### Example 2A. Cambrian SP22, Sand Floating Test

Sixty grams of 40/70 US mesh frac sand was mixed with 0.3 mL of Cambrian Camguard SP22 (Cambrian Solutions Inc., Oakville, ON, Canada), which is an aqueous dispersion of 30% alkoxysilane-modified polyurethane, to form a polyurethane coated sand. After being dried, the coated sand was added into a lab blender which contained 200 ml of a 0.1 wt % polyacrylamide aqueous solution. The slurry was sheared at 3000 rpm for 15 seconds. It was observed that almost all of the sand was floating on the top of slurry.

### Example 2B. Cambrian SP22, Crush Resistance Test

Forty grams of 40/70 US mesh frac sand was mixed with 0.2 mL of Cambrian Camguard SP22, which is an aqueous dispersion of 30% alkoxysilane-modified polyurethane, to form a polyurethane coated sand. After the coated sand was dried, the coated sand was subjected to a crush resistance test conducted under 5000 psi by using standard (ISO 13503-2) procedures. Test results shows 7.3 wt % fines were generated for the untreated sand after crushing. By comparison, 5.9 wt % fines were generated for the polyurethane coated sand under the same experimental conditions, constituting an approximately 19% fine reduction with the coated sand as compared to the uncoated sand.

### Example 2C. Cambrian SP22, Turbidity Test

Thirty grams of 40/70 US mesh frac sand was mixed with 0.15 ml of Cambrian Camguard SP22, which is an aqueous solution of 30% alkoxysilane-modified polyurethane, to form a polyurethane coated sand. After being dried, the coated sand was added into a glass bottle containing 100 mL of distilled water. The bottle was shaken for 30 seconds and then let it stand for 5 minutes. Afterwards 25 mL of the water was extracted and turbidity was measured on a HACH spectrometer at 450 nm wavelength. Result shows the turbidity of the coated sand was 5 FTU. By comparison, the turbidity of untreated sand, under the same experimental conditions, was 23 FTU.

In accordance with various aspects of the present disclosure, various proppants, especially sands and ceramic proppants, can be treated during a manufacturing process, where the proppants are reacted with a silicone-modified hydrophobic polymer and then transported to the well site for the fracturing operations. With the compositions provided herein, high concentrations of proppants can easily be pumped into a formation and the proppants are more evenly distributed in the fracture, leading to improved proppant conductivity. In some embodiments, the hydrophobically-coated particulates in the slurry tend to agglomerate and move cohesively in contrast to conventional slurries under the same conditions and exhibit increased crush resistance.

Similarly, one can use pre-hydrophobised proppants to make the slurry while the slurry is pumped into the well during a fracturing operation. Another benefit of the slurries of the present invention is that the aqueous liquid can be re-used after it is separated from the proppants after a fracturing operation. This has great significance considering there is limited water supply in the world for hydraulic fracturing operations.

All publications, patents and patent applications cited herein are hereby incorporated by reference as if set forth in their entirety herein. While this invention has been described with reference to illustrative embodiments, this description is not intended to be construed in a limiting sense. Various modifications and combinations of illustrative embodiments, as well as other embodiments of the invention, will be apparent to persons skilled in the art upon reference to the description. It is therefore intended that the appended claims encompass such modifications and enhancements.

What is claimed is:

1. A composition of matter comprising:
a particulate; and
a hydrophobic polymer coated onto a surface of the particulate,
wherein the hydrophobic polymer is bound to the surface of the particulate via a silicon-oxygen-silicon linkage.

2. The composition of claim 1, wherein the particulate is sand.

3. The composition of claim 1, wherein the hydrophobic polymer comprises a poly-α-olefin.

4. The composition of claim 1, wherein the hydrophobic polymer comprises a polyurethane.

5. The composition of claim 1, wherein the hydrophobic polymer comprises any one of a poly-1,2-butadiene, an ethylene-(35-40% 1,4-butadiene)-(25-30% styrene) terpolymer, an acrylic, a methacrylate, and a polyethylene.

6. The composition of claim 1, wherein the hydrophobic polymer an oligomeric hydrosylate or an oligomeric co-hydrosylate.

7. An aqueous slurry composition, the composition comprising:
a composition of matter according to claim 1; and
an aqueous liquid.

8. The composition of claim 7, wherein the aqueous liquid is any one of water and slick-water.

9. The composition of claim 8, wherein the aqueous liquid further comprises one or more of a salt and an organic solvent.

10. The composition of claim 7, further comprising a frother.

11. The composition of claim 10, wherein the frother is one or more of an aliphatic alcohol, a cyclic alcohol, an alkoxy paraffin, a polyglycol ether, polyglycol glycerol ether and a polypropylene glycol ether.

12. The composition of claim 7, further comprising an oil.

13. The composition of claim 12, wherein the oil is any one of a paraffin oil and a mineral oil.

14. The composition of claim 7, further comprising a gas.

15. The composition of claim 14, wherein the gas is selected from the group consisting of air, carbon dioxide, nitrogen, methane, and any mixture thereof.

16. The composition of claim 7, further comprising at least two of a frother, an oil, and a gas.

17. A method of making a hydrophobically-coated particulate, the method comprising:
treating a particulate with a solution, the solution comprising:
a solvent; and
a silicone-modified hydrophobic polymer.

18. The method of claim 17, wherein treating the particulate with the solution is performed in a reaction vessel.

19. The method of claim 17, wherein treating the particulate with the solution is performed by spraying the solution onto the particulate.

20. The method of claim 17, wherein the silicone-modified hydrophobic polymer has the following formula: 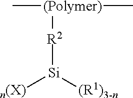
wherein
n is an integer ranging from 1 to 3;
X is an alkoxy group such as —OCH₃, —OCH₂CH₃, —OCH₂CH₂CH₃, —OC(CH₃)₃, —OCH₂CH₂OCH₃, or a halogen such as Cl, Br, I or F (preferably Cl or Br);
R¹ is a functional group such as —H, —CH₃, —(CH₂)ₘCH₃ (m=1-23), —C₆H₅, —C₆H₄R (R=a hydrophobic group such as, but not limited to, a C₁-C₂₄ saturated or unsaturated, branched or linear alkyl group, a halogen, a vinyl, an alkoxy, an aromatic hydrocarbon, a cyclic hydrocarbon, etc.), —HC═CH₂, —(CH₂)ₘHC═CH₂ (m=1-23), —C≡CH, —(CH₂)ₘC≡CH (m=1-23), a cyclic hydrocarbon or a branched alkane such as a isopropyl, iso-, tert-, or sec-butyl, iso-, tert-, or sec-pentyl, iso-, tert- or sec-hexyl, iso-, tert-, or sec-heptyl, iso-, tert- or sec-octyl;
R² is a linear or branched, substituted or unsubstituted, alkyl, alkenyl or alkynyl chain having 1 to 24 carbons; and
Polymer is selected from the group consisting of a poly-α-olefin, a polyurethane; a poly-1,2-butadiene, an ethylene-(35-40% 1,4-butadiene)-(25-30% styrene) terpolymer, a polyolefin, a polyvinyl, a polystyrene, an acrylic, a methacrylate, an oligomeric hydrosylate, an oligomeric co-hydrosylate.
